(19) United States
(12) Patent Application Publication
(10) Pub. No.: US 2023/0014741 A1
(43) Pub. Date: Jan. 19, 2023

(54) DYNAMIC CROSS-ARCHITECTURE APPLICATION ADAPTION

(71) Applicant: Intel Corporation, Santa Clara, CA (US)

(72) Inventors: Antonio Valles, Mesa, AZ (US); Rebecca David, Santa Clara, CA (US)

(73) Assignee: Intel Corporation, Santa Clara, CA (US)

(21) Appl. No.: 17/945,290

(22) Filed: Sep. 15, 2022

(51) Int. Cl. G06F 9/50

(52) U.S. Cl. CPC G06F 9/505; G06F 9/5077; G06F 9/5072; G06F 2209/505; G06F 2209/5019

(57) ABSTRACT

Embodiments described herein are generally directed to improving performance of high-performance computing (HPC) or artificial intelligence (AI) workloads on cluster computer systems. According to one embodiment, a section of a high-performance computing (HPC) or artificial intelligence (AI) workload executing on a cluster computer system is identified as significant to a figure of merit (FOM) of the workload. An alternate placement among multiple heterogeneous compute resources of a node of the cluster computer system is determined for a portion of the section currently executing on a given compute resource of the multiple heterogeneous compute resources. After predicting an improvement to the FOM based on the alternate placement, the portion is relocated to the alternate placement.

### TECHNICAL FIELD

Embodiments described herein generally relate to the field of high-performance computing (HPC) and workload optimization and, more particularly, to observing and optimizing application behavior as it runs a given workload by identifying sections/subsections of code that contributed to the figure of merit (FOM) and predicting whether such sections/subsections will benefit with new placements.

### BACKGROUND

Many companies/nations/labs are heavily invested in supercomputers, for example, in the form of computing clusters (e.g., HPC computing clusters) to solve complex problems relating to national defense, public health, weather, space research, and the like. These supercomputers may be made up of a complex heterogeneous combination of compute resources (e.g., central processing units (CPUs), CPU cores, graphics processing units (GPUs), GPU cores, and/or field-programmable gate arrays (FPGAs)), other accelerators, and various interconnects.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is a block diagram illustrating an example of a high-performance computing (HPC) cluster and a workload optimization system according to some embodiments.

FIG. 2 is a block diagram illustrating an example of a computing node of an HPC cluster.

FIG. 3 is a block diagram illustrating another example of a computing node of an HPC cluster.

FIG. 4 is a flow diagram illustrating operations for performing dynamic relocation of workload portions according to some embodiments.

FIG. 5 is a flow diagram illustrating operations for performing identification of sections of a workload that are significant to a figure of merit (FOM) according to some embodiments.

FIG. 6 is a block diagram conceptually illustrating a binary executable.

FIG. 7 is an example of a computer system with which some embodiments may be utilized.

### DETAILED DESCRIPTION

Embodiments described herein are generally directed to improving performance of high-performance computing (HPC) or artificial intelligence (AI) workloads on cluster computer systems. As noted above, supercomputers may be made up of a complex heterogeneous combination of compute resources and various interconnects. This complexity has created two significant gaps. First, there is an inability on the part of a given HPC or AI workload to fully utilize all the resources of a cluster computer system. Second, developers are unable to fully optimize a given HPC or AI workload for future cluster computer system architectures that might have different set of compute resources and interconnects.

Various embodiments of the present technology seek to address or at least mitigate the gaps described above by, for example, among other things, determining whether there are underutilized resources within a cluster computer system during iterations of a workload and evolving the workload so future iterations better utilize the resources of the cluster computer system. In one embodiment, during execution of an HPC or AI workload on a cluster computer system, a section of the workload may be identified as significant to the FOM of the workload, for example, via hardware features and/or software techniques. The section (e.g., one or more blocks of related logic, one or more sequences of instructions, one or more functions, one or more procedures, a series of one or more loops, one or more nested loops, and/or a combination thereof) may be identified based on annotations embedded within a binary representation of the workload or based on repeated execution. Repeated execution of the section may be observed based on software-based function interposition, run-time code profiling (e.g., how often lines of code are executed), and/or sampling of hardware-based performance counters. An alternate placement among the heterogeneous compute resources may then be determined for a portion of the section currently executing on a compute resource of multiple heterogeneous compute resources of a node of the cluster compute system. For example, a GPU may be identified as an alternative for a compute portion (e.g., a set of instructions that can execute on a CPU, a GPU, or a combination of both) currently executing on a CPU and vice versa. Similarly, a GPU may be identified as an alternative for a communication portion (e.g., a set of instructions representing data exchanges between processes (e.g., message passing interface (MPI) application programming interfaces (APIs)) or data transfers between compute resources) currently executing on a CPU and vice versa to minimize or hide data transfer cost. Based on the alternative placement, a prediction may be made regarding the impact to the FOM. When an improvement to the FOM is predicted, the portion of the workload may be relocated to the alternative placement. These steps may be repeated until all compute and communication portions of the section are processed for optimal placement and all sections that contributed significantly to the FOM have been considered.

While for simplicity various examples may be described with reference to serial evaluation of sections and/or portions of sections of a workload, in other examples multiple portions of sections of significance to the FOM can be evaluated and/or relocated all at once instead of serially.

In the following description, numerous specific details are set forth in order to provide a thorough understanding of example embodiments. It will be apparent, however, to one skilled in the art that embodiments described herein may be practiced without some of these specific details.

### Terminology

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

As used herein, a “workload” generally refers to an application and/or what the application runs based on the context in which the term is used.

As used herein, an “HPC or AI workload” generally refers to a workload that solves a computationally intensive task. Non-limiting examples of such workloads range from genomics (e.g., gene mining to combat a pandemic) to machine-learning models (e.g., deep learning recommendation models (DLRMs)) intended to predict what users might like, for example, to drive engagement (e.g., click through rates) on social media platforms and further include simulation of nuclear devices for national security, oil and gas simulations, and high-performance dynamic simulations of biomolecules (e.g., the GROningen MAchine for Chemical Simulation (GROMACS) software package). Typically, HPC or AI workloads include long-lived processes that are highly iterative in nature.

As used herein, a “figure of merit” or “FOM” is used by a developer to designate a region of importance in a workload. FOM generally refers to a quantity, measure, or numerical expression used to characterize the performance or efficiency of a device, system or method, for example, relative to its alternatives. Typically, the FOM of a workload is expressed in terms of time (e.g., latency and/or time to complete a particular function or set of activities); however, the FOM could also be measured in terms of bandwidth, operations per unit of time (e.g., floating point operations per second (FLOPS), work (e.g., memory operations), efficiency, effectiveness, precision, accuracy, failure rate, and/or sustained performance).

As used herein, the term “function” generally refers to a self-contained module of code that accomplishes a specific task. A non-limiting example of a function is an API call.

As used herein, the term “section” of a workload generally refers to a set of instructions of the workload. Non-limiting examples of a section include one or more blocks of related logic, one or more sequences of instructions, instructions associated with one or more functions, instructions associated with one or more procedures, instructions representing a series of one or more loops, instructions representing one or more nested loops, and/or a combination thereof.

As used herein, the term “portion” of a section generally refers to a subset of instructions of the section. Non-limiting examples of a portion include one or more blocks of related logic of a section including multiple blocks of related logic, one or more sequences of instructions of a section including multiple sequences of instructions, instructions associated with one or more functions of a section including multiple functions, instructions associated with one or more procedures of a section including multiple procedures, instructions representing a series of one or more loops of a section including a series of multiple loops, and/or instructions representing one or more nested loops of a section including multiple nested loops.

As used herein, a given portion or section of a workload is “significant” to the FOM when the given portion or section of the workload is sufficiently great or important to be worthy of attention. According to one embodiment, a given portion or section of a workload is considered significant to the FOM when it is in a critical path of the workload. A critical path of a workload may refer to a sequence of activities (out of all the possible sequences within the workload) that adds up to the longest overall duration. Such a critical path is typically the first target for optimization. A non-limiting example of a critical path of a workload is a scenario in which multiple portions or sections of the workload can be executed in parallel but one of the paths takes longer to execute and shortening this path improves the FOM. Another non-limiting example of a critical path of a workload is a scenario in which a portion or section of the workload is repeated multiple times and its sum of times takes a percentage of the FOM above a certain threshold defined by the implementation to deem it significant.

As used herein, a “fat binary” (which may also be referred to as a multiarchitecture binary) generally refers to a computer executable program or library that has been expanded (or “fattened”) with code native to multiple instruction sets for corresponding compute resources. As a result, a fat binary is not restricted to a specific compute resource since a fat binary can run on multiple types of compute resources.

### Example Operating Environment

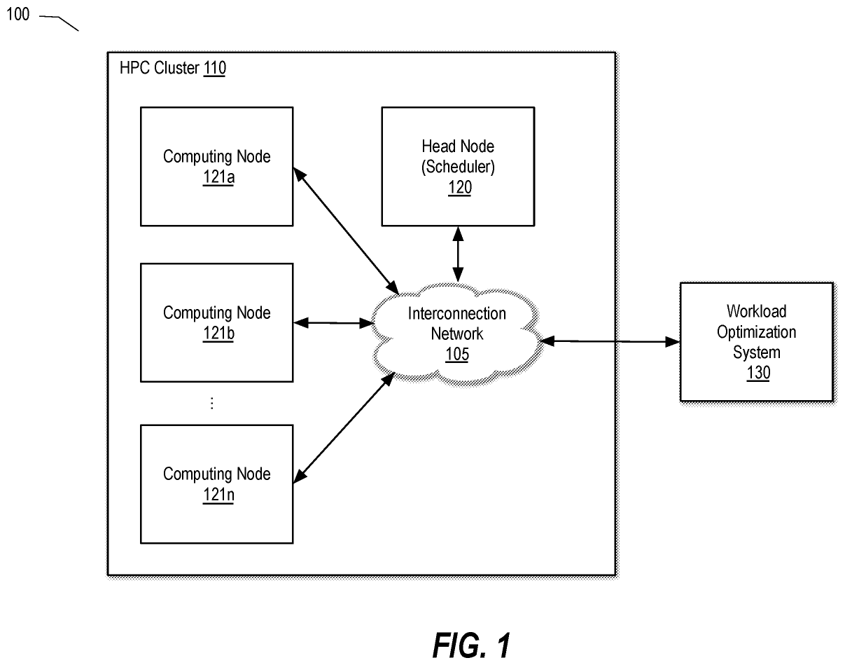

FIG. 1 is a block diagram illustrating an example of a high-performance computing (HPC) cluster 110 and a workload optimization system 130 according to some embodiments. While HPC workloads may be run on a single server or node, the real potential of HPC comes from running computationally intensive tasks as processes across multiple nodes (e.g., computing nodes 121a-n). In this manner, these different processes may work together in parallel as a single application. To provide communication between processes across the multiple nodes, a messaging passing mechanism is typically implemented. The most common implementation of the message passing mechanism in HPC is known as Message Passing Interface (MPI). MPI is a communication protocol and a standard used to enable portable message passing, for example, from a buffer in memory from one process to another process that can be on the same computing node or on a different node. When one process sends a message, another process can receive the message irrespective of whether the processes are on the same node or on different nodes. As a result, computational workloads can be run across multiple nodes that are connected via high speed networking links, thereby allowing organizations to solve their computational problems at a lower cost and at a greater scale. Non-limiting examples of implementations of MPI solutions include Open MPI, MPICH, MVAPICH, and Intel MPI.

Another approach for parallel programming commonly used in clusters is partitioned global address space (PGAS). As those skilled in the art will appreciate machine-learning (ML)/AI workloads can use other mechanisms, such as remote procedure calls. In addition, HPC applications can use MPI or other parallel mechanisms with the following to offload sections or portions of a workload to a GPU: open multi-processing (OpenMP), open accelerators (OpenACC), compute unified device architecture (CUDA) APIs, open computing language (OpenCL) APIs, SYCL APIs, Intel OneAPI, and/or vendor specific math library calls (e.g., Math Kernel Library (MKL) calls).

In the context of the present example, the HPC cluster 110 includes multiple computing nodes 121a-n, a head node (or scheduler) 120 of potentially multiple head nodes, and an interconnection network 105. The head node 120 may act as an entry point into the HPC cluster 110 and may also include a scheduler. For example, users (not shown) may interact with the input and/or output of their workloads and get access to local storage systems (not shown) available to the HPC cluster 110. The head node 120 may also be where the users schedule their workloads. The scheduler, in turn, queues up workloads against the cluster resources and executes processes on the computing nodes 121a-n.

The interconnection network 105 is generally used for communication between the computing nodes 121a-n. For example, the interconnection network 105 may be used for parallel MPI application communication between the computing nodes 121a-n. Depending upon the particular implementation, the interconnection may be in the form of a network fabric including one or more InfiniBand or high performing Ethernet network switches.

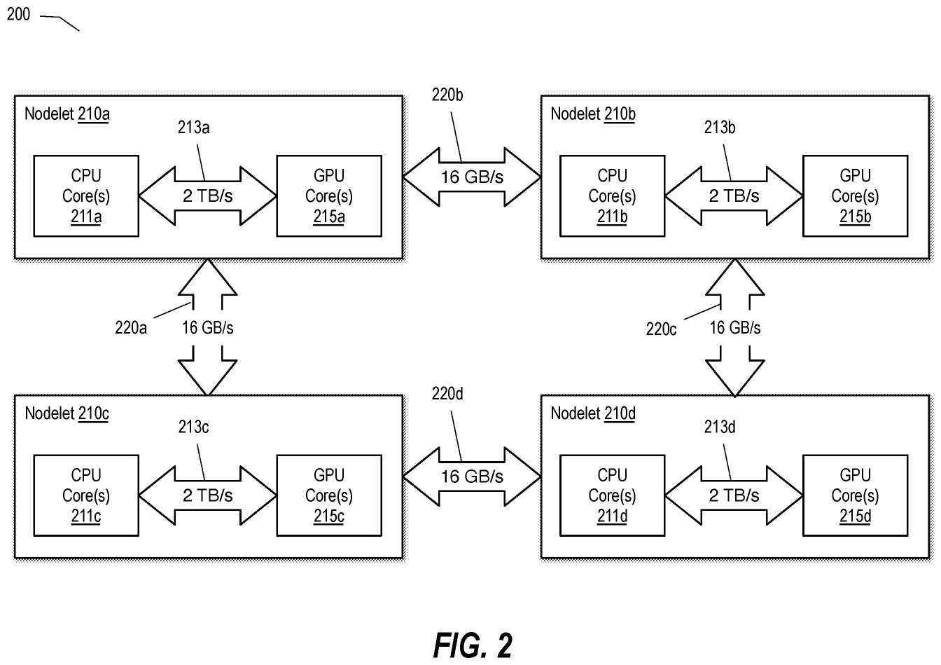

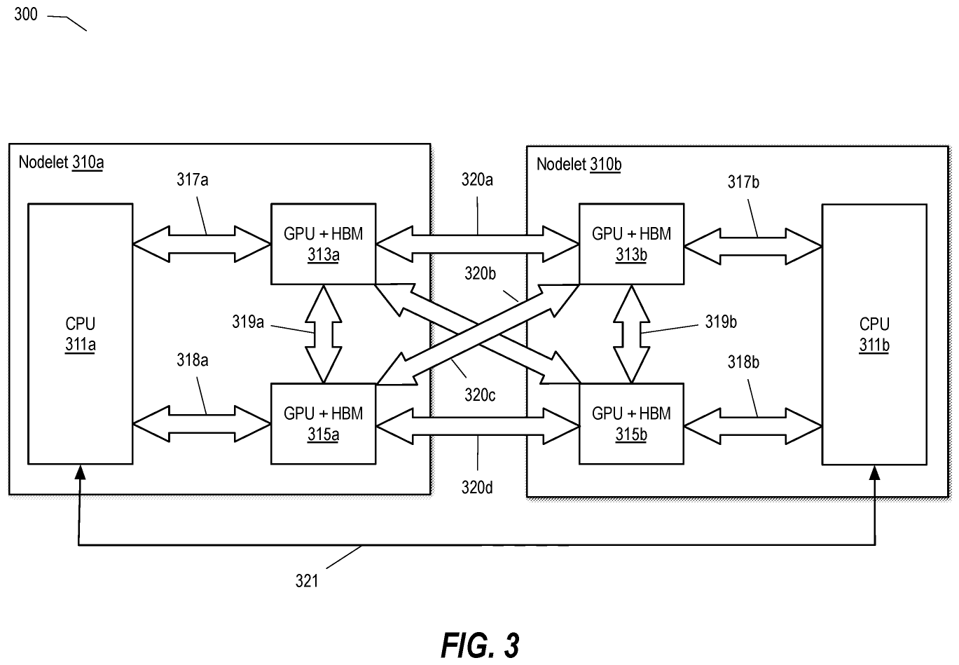

The computing nodes 121a-n may represent server computer systems including a heterogeneous combination of compute resources (e.g., CPUs, CPU cores, GPUs, GPU cores, and/or FPGAs), other accelerators (e.g., AI accelerators or heterogeneous companion cores (either on-die or off-die)), and various interconnects between and/or among the compute resources. Non-limiting examples of computing nodes 121a-n are described further below with reference to FIGS. 2 and 3.

In one embodiment, to facilitate dynamic run-time relocation of a given section of a workload or one or more particular portions of the given section, the HPC or AI application should be executed on the HPC cluster 110 in the form of a fat binary that includes code native to instruction sets of multiple compute resources represented within the HPC cluster 110.

### Example Computing Nodes

FIG. 2 is a block diagram illustrating an example of a computing node 200 of an HPC cluster (e.g., HPC cluster 110). In the context of the present example, the computing node 200 (which may be analogous to computing nodes 121a-n) includes four nodelets 210a-d each having respective CPU cores 211a-d, respective GPU cores 215a-d, for example, on the same, and with respective interconnects 213a-d therebetween providing an interconnect speed of up to 2 terabytes per second (TB/s). Nodelet-to-nodelet direct connectivity may be based on a bi-directional ring topology of inter-nodelet interconnects 220a-d providing data transfer speeds of up to 16 gigabytes per second (GB/s).

FIG. 3 is a block diagram illustrating another example of a computing node 300 of an HPC cluster (e.g., HPC cluster 110). In the context of the present example, the computing node 300 (which may be analogous to computing nodes 121a-n) includes two nodelets 310a-b each having respective CPUs 311a-b and respective pairs of GPUs and high-bandwidth memories (HBMs) 313a-b and 315a-b.

A given CPU (e.g., CPU 311a or CPU 311b) may be coupled to given GPUs+HBM (e.g., GPU+HBM 313a and GPU+HBM 315a or GPU+HBM 313b and GPU+HBM 315b) via peripheral component interconnect express (PCIe) bus (e.g., PCIe bus 317a and 318a or PCIe bus 317b and 318b), for example, PCIe gen-5 with data transfer speeds of up to 64 GB/s. A given intra-nodelet GPU interconnect (e.g., GPU-to-GPU interconnects 319a-b) and a given inter-nodelet GPU interconnect (e.g., GPU-to-GPU interconnects 320a-d) may provide data transfer speeds of up to 16 GB/s.

The example nodes of FIGS. 2 and 3, illustrate why different targeted optimizations may be performed for two different target systems. For example, one of the main differences between nodes 200 and 300 is the data transfer rate between CPU and GPU. The relatively low data transfer rate on node 300 might represent such a large bottleneck that consideration should be given to moving compute section portions of a given workload from GPU to CPU to avoid the data transfer costs even if the compute sections are not best suited for GPU. In contrast, for node 200, where the CPU-to-GPU data transfer rate is —32x faster than node 300, it may be best to relocate the same compute section that is not optimized for GPU to the CPU.

As described further below, various other architectural features of the nodes of an HPC cluster may be taken into consideration in connection with identifying alternative placement options, predicting behavior of a given section/portion on a given alternative placement option, and/or computing a new FOM based on the given alternative placement option. For example, in one embodiment, parallel efficiency (e.g., the number of parallel threads and/or degree of vectorization), the number of concurrent contexts allowed, and/or other architectural features that can suit the workload may be factored into the determination of whether a given code section or one or more portions thereof should be dynamically relocated.

### Example Dynamic Relocation of Workload Portions

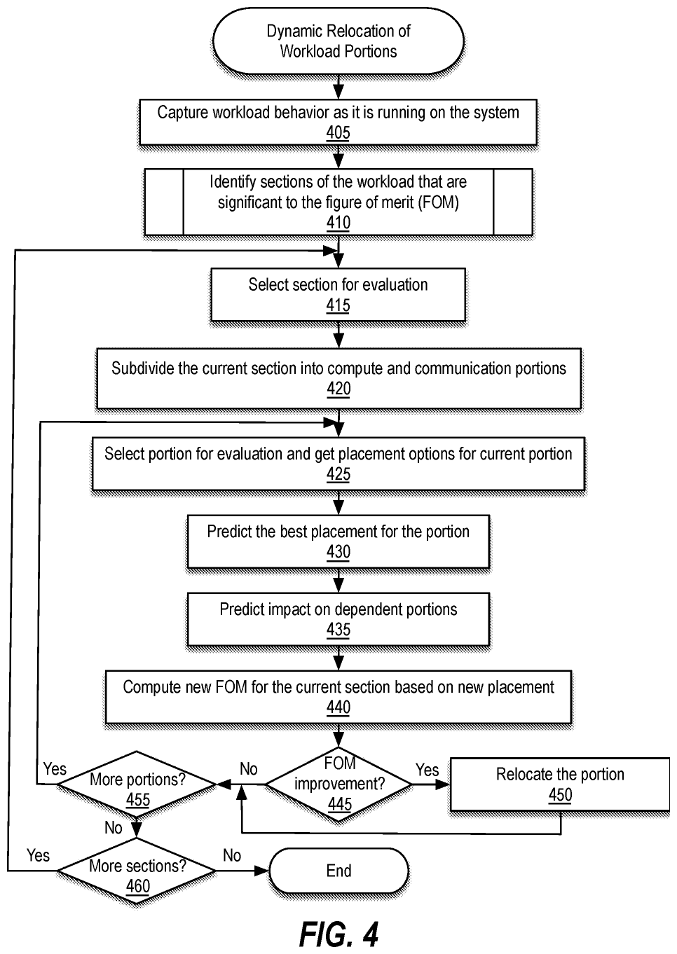

FIG. 4 is a flow diagram illustrating operations for performing dynamic relocation of workload portions according to some embodiments. In one embodiment, the processing described with reference to FIG. 4 may be performed by a workload optimization system (e.g., workload optimization system 130). In other embodiments, the workload optimization system may alternatively be software running on a head node (e.g., head node 120), on each computing node (e.g., computing nodes 121a-n), or in the background of each process.

In the context of FIG. 4, it is assumed a workload (e.g., an HPC or AI workload) is running on a target system in the form of a cluster computer system (e.g., HPC cluster 110). Most HPC or AI workloads are repetitive or iterative in nature. In one embodiment, as the application runs, initial iterations can be used to understand the current behavior of the workload and predict whether the performance will improve when certain portions are relocated to use different compute resources. By tracking the behavior of the workload and predicting potential performance improvements, and dynamically relocating the performance of different sections of the code, the application performance per iteration should improve significantly as the application evolves to better take advantage of the architectural features of the target system.

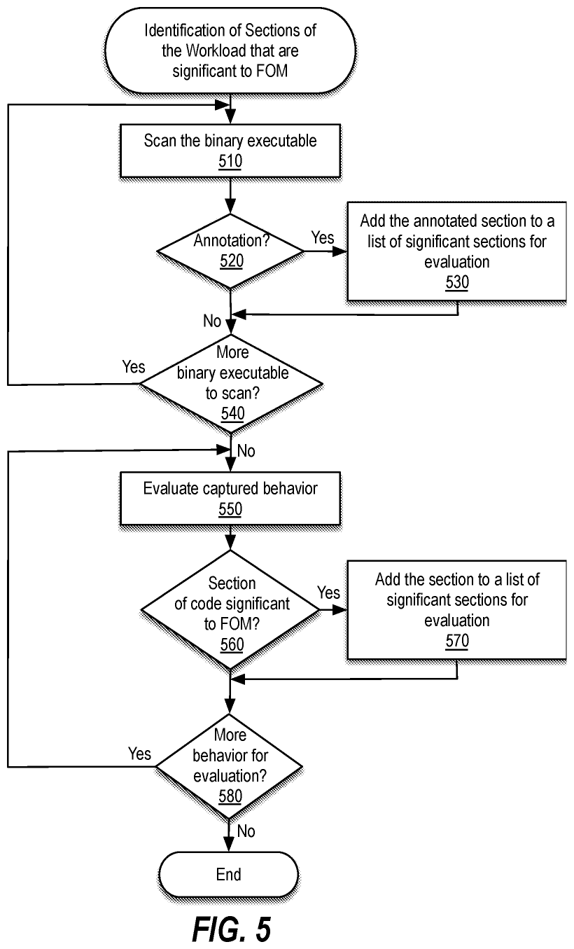

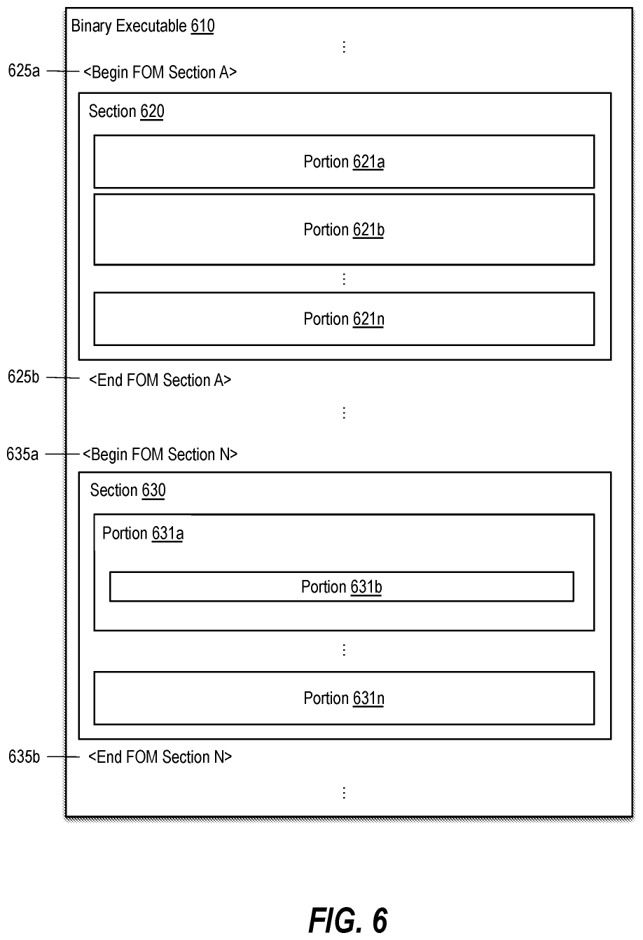

According to one embodiment, the application code or binary executable (e.g., a fat binary) includes multiple target implementations (e.g., one implementation for each of the compute resources available on the target system) for various sections of the workload or portions thereof (e.g., key functions/loops) that are significant to the FOM. In this manner, such sections/portions can be optimized (e.g., relocated) on the fly by the workload optimization system. For purposes of illustration and without limitation, some of the blocks of FIGS. 4 and 5 may be described with reference to FIG. 6, which is a block diagram conceptually illustrating a binary executable 610. The binary executable 610 may be a fat binary including code that is native to multiple instruction sets of respective compute resources of the target system. In the context of FIG. 6, the binary executable 610 includes multiple sections (e.g., sections 620 and 630) that each include multiple portions (e.g., portions 621a-n and portions 631a-n, respectively).

At block 405, behavior of the workload is captured as it is running on the target system. There are various mechanisms to capture behavior of a workload, including static and dynamic code analysis. Static code analysis may involve examination of the code, for example, the assembly code corresponding to the machine code contained within a binary executable of the workload. Dynamic code analysis may involve running code and examining the outcome, which may also entail monitoring various execution paths of the code and/or counting the number of times various instructions are executed (dynamic instruction count). Dynamic code analysis may also include determination of dependencies between various code sections and/or portions thereof, data locality, memory locality, and/or obtaining information regarding various hardware counters. In one embodiment, function interposition and/or event queries may be used to facilitate dynamic code analysis. For example, function interposition may be used to intercept calls to certain library functions to count and/or time the performance of such calls. While in the context of various examples described herein, behavior of the workload may be described as being captured during runtime, it is to be appreciated static analysis need not be performed during runtime and may instead be performed separate and apart from dynamic analysis prior to runtime.

At block 410, sections (e.g., one of more of sections 620 and 630) of the workload that are significant to the FOM may be identified. As noted above, a section of a workload may be one or more blocks of related logic, one or more sequences of instructions, one or more functions, one or more procedures, a series of one or more loops, one or more nested loops, and/or a combination thereof. A given section of a workload that is significant to the FOM of the workload may be specifically identified, for example, based on annotations (e.g., 625a, 625b, 635a, and/or 635b) embedded within a binary representation of the workload or inferentially identified, for example, based on repeated execution. A non-limiting example of identification of sections of the workload that are significant to the FOM is described further below with reference to FIG. 5.

At block 415, a section of those identified as being significant to the FOM is selected for evaluation. The sections may be processed in the order in which they appear in the binary executable or may be prioritized in accordance with their respective contributions to the FOM. A data structure may be maintained to track which sections have been evaluated and which remain to be evaluated.

At block 420, the current section (the section selected at block 415) is subdivided into compute and communication portions. As noted above, a portion (e.g., one of portions 621a-n or 631a-n) of a workload may represent a subset of instructions of a given section. Non-limiting examples of a portion include one or more blocks of related logic of the given section that includes multiple blocks of related logic, one or more sequences of instructions of the given section that includes multiple sequences of instructions, instructions associated with one or more functions of the given section that includes multiple functions, instructions associated with one or more procedures of the given section that includes multiple procedures, instructions representing a series of one or more loops of the given section that includes a series of multiple loops, and/or instructions representing one or more nested loops of the given section that includes multiple nested loops.

In one embodiment, a compute portion represents a subset of instructions of a given section that can execute on a compute resource or a combination of multiple compute resources of the target system at issue, whereas a communication portion may represent a subset of instructions of the given section involving one or more data exchanges between processes (e.g., MPI APIs) or data transfers between or among compute resources.

A non-limiting example of distinguishing between compute and communication portions of a section may involve using a shim layer to interpose driver calls and/or library calls that are associated with communication. For example, memory copy from CPU host to GPU device or vice versa. Another example would be interposing a communication API call. Other methods that can be used to distinguish between compute and communication calls is capturing memory behavior between devices and/or bus behavior through hardware performance event counters on CPU, GPU, and PCIe (e.g., memory-mapped input/output (MMIO) events).

At block 425, a portion (of those portions identified in block 420) of the current section is selected for evaluation and alternative placement options for the selected portion are identified. A data structure may be maintained to track the various portions of the current section, whether evaluation of a given alternative placement option has been completed, and whether a given portion has been categorized as a compute or communication portion. Depending upon the particular implementation, portions may be selected in order of their appearance as part of a top-down scan of the current section or portions within a given section may be prioritized for evaluation in accordance with their respective predicted contribution to the FOM.

In one embodiment, all or some subset of other compute resources (other than the compute resource on which the current portion is currently running) available within the target system and/or the node at issue are added to a list of alternative placement options for the selection portion. According to one embodiment, historical information may be taken into consideration. For example, predictions and/or actual metrics associated with historical placement options from prior iterations of the workload may be used to inform inclusion/exclusion of certain types of compute resources within the list of available compute resources and/or may be used to inform selection among them.

At block 430, a prediction is made to determine the best placement for the current portion (the portion selected in block 425) among the alternative placement options. Depending upon the particular implementation, each of the alternative placement options or a subset thereof may be evaluated with respect to various factors that might improve the FOM. For example, the prediction may involve evaluating whether the relocation of the current portion to a given alternative compute resource impacts (e.g., increases or decreases) (i) expected data transfer via interconnects coupling the multiple heterogeneous or homogeneous compute resources in communication, (ii) expected memory access costs, and/or (iii) expected compute efficiency as compared to the current compute resource placement. The prediction may take into consideration a difference in power consumption or thermals, scheduling schemes, and/or improved concurrency. Additionally or alternatively, parallel efficiency (number of parallel threads and/or degree of vectorization), the number of concurrent contexts allowed and/or other architectural features that might benefit the workload may be considered. In one embodiment, the prediction includes predicting the behavior of the current portion on a given alternative placement option. This may include predicting the behavior based on one or more of (i) a different non-uniform memory access (NUMA) node or a different socket, (ii) a different device/sub-device/sub-sub-device, (iii) a different stream of execution; and/or (iv) memory locality. In one embodiment, various predicted and/or actual metrics calculated during evaluation of a given alternative placement option as well as characteristics/attributes of the current portion (e.g., whether it has been categorized as a compute or communication portion) may be logged for use in subsequent iterations and/or subsequent runs of the workload.

At block 435, a prediction is made to determine the impact of relocating the current portion on dependent portions. Dependent portions may represent other portions of code within the same section that have run-time data dependencies, interactions with, or other dependencies on the current portion. Depending upon the particular implementation, the data dependent portions for a given portion may be determined based on behavior captured during dynamic code analysis (e.g., tracking memory dependencies).

At block 440, a new FOM is computed for the current section based on the proposed new placement alternative. For example, the time, latency, or other quantity or metric at issue may be calculated from the beginning of the current section to the end of the current section for the current section assuming the current portion is relocated to the proposed new placement alternative. For example, the new FOM may be calculated with reference to known operational characteristics (e.g., rates of instruction execution), configuration and/or features of the proposed new placement alternative as well as interconnections (e.g., data transfer capacity) between the new placement alternative and other compute resources of the node or nodelet at issue.

At decision block 445, it is determined whether the alternative placement of the current portion will result in an improvement over the current FOM. If so, processing continues with block 450; otherwise processing branches to decision block 455. The determination may involve comparing a current FOM, representing the FOM of the current section in accordance with the current configuration of the workload, to the new FOM calculated in block 440. In one embodiment, as the workload continues to run, the FOM for the current configuration/placement of various sections/portions of the workload may be calculated and persisted as they are encountered to maintain historical versions of the FOM for various configuration/placement options.

At block 450, the current portion is relocated. In one embodiment, the target implementation within the binary executable for the compute resource representing the newly selected placement alternative may be loaded and executed on the compute resource. For example, a “fat” binary relocation may be done via a branch. A branch variable may be made accessible via a library call, thread local storage, and/or an environment variable. Branch targets can also be modified via dispatch tables, trampolining, interposition, or thunking. In one embodiment, actions performed (e.g., relocation of portions of the workload) to optimize the workload may be logged for use in subsequent iterations and/or subsequent runs of the workload.

At decision block 455, it is determined whether there is another portion of the current section to evaluate. If so, processing loops back to block 425; otherwise, processing branches to decision block 460.

At decision block 460, it is determined whether there is another section of the workload to evaluate. If so, processing loops back to block 415; otherwise, the workload optimization processing is complete.

A non-limiting example in which it might be helpful to perform dynamic relocation of workload portions may involve a scenario in which most of the portions of a section are executing on the GPU and the portions executing on the CPU require memory transfers from GPU to CPU to execute the portion on CPU then transfers from CPU to GPU to do the subsequent portions on the GPU. In this example, the portions running on the CPU may have initially been placed on the CPU due to the code being scalar or otherwise having been deemed to be more performant on CPU than on GPU. Using the proposed approach, dynamic profiling may detect the multiple memory transfers. The proposed approach may further determine that the cost of the memory transfers are greater than if the CPU scalar portion(s) are relocated to be executed on the GPU even if it is not executed optimally on the GPU.

### Example Identification of Significant Sections of a Workload

FIG. 5 is a flow diagram illustrating operations for performing identification of sections of a workload that are significant to a figure of merit (FOM) according to some embodiments. The processing described with reference to FIG. 5 represents a non-limiting example of processing that may be performed at block 410 of FIG. 4. In the context of the present example, blocks 510-540 may represent a static code analysis and blocks 550-580 may represent a dynamic code analysis that may be performed during execution (run-time) of the workload. While for sake of brevity, the static code analysis is described as being performed with the dynamic code analysis, those skilled in the art will appreciate the static code analysis may be performed prior to run-time or during run-time.

At block 510, the application code or a corresponding binary executable (e.g., binary executable 610) may be scanned to identify various sections (e.g., sections 620 and/or 630) of the workload that are significant to the FOM. As noted above, such sections may be marked by annotations (e.g., annotations 625a-b, which identify the beginning and end, respectively, of section 620 and annotations 635a-b, which identify the beginning and end, respectively, of section 630). Assuming annotations exist within the binary executable, the scan may employ pattern matching to identify them. For example, as tokens of the binary executable are sequentially parsed from the binary executable, the tokens may be compared to a particular pattern representing a section start marker. In other embodiments, an interrupt (e.g., INT3) may be used to mark the start and/or end of a section. Alternatively, an operation or function (e.g., MPI Pcontrol( )) that enables and/or disables statistics collection or profiling control for specific workflow regions in the source code may be used.

At decision block 520, it is determined whether an annotation has been encountered during the scan of the binary executable. If so, processing branches to block 530; otherwise, processing continues with decision block 540.

At block 530, the annotated section (e.g., section 620, bounded by annotations 625a-b) is added to a list of significant sections for subsequent evaluation.

At decision block 540, it is determined whether there is more of the binary executable to be scanned. If so, processing loops back to block 510; otherwise, processing continues with block 550.

At block 550, behavior captured during run-time is evaluated. In one embodiment, the behavior of interest at this point is an amount of work (e.g., memory operations) performed by a given section of a workload and/or the repetition of a set of instructions. For example, when no annotations are present within the binary executable to facilitate identification of sections of the workload that are significant to the FOM, the amount of work performed and/or repetition of a continuous set of instructions within the binary executable may be used as an indicator of significance to the FOM. According to one embodiment, run-time code profiling and/or sampling of hardware-based performance counters may be used to identify “hot” areas of the workload.

At decision block 560, a determination is made regarding whether a given section is considered significant to the FOM. A metric may be used to measure the amount of work done by a given section of a workload and a threshold of that metric can be used to decide if the given section is considered significant to the FOM. In addition, in HPC, a common idiom of the relative importance of a section of a workload is also how often that section repeats. In one embodiment, if the given section of the workload is taking a significant amount of time as indicated by exceeding a predetermined or configurable threshold, performs a predetermined or configurable threshold of work, and/or it has a repeating nature, then it can be deemed worthy of further evaluation. As those skilled in the art will appreciate, instruction execution counts represent a non-limiting example of a mechanism that may be used to evaluate the repeating nature of a given section of code of a workload. Based on the foregoing, if the given section of code is considered significant to the FOM, processing branches to block 570; otherwise, processing continues with decision block 580.

At block 570, all or some subset of sections of the workload identified as worthy of further evaluation by decision block 560 may be added to a list of significant sections for evaluation. According to one embodiment, all repeating sections of code may be sorted in descending order of their respective instruction execution counts. A predetermined or configurable percentage (e.g., the top 50%) of the repeating sections may then be added to the list of significant sections for subsequent evaluation.

At decision block 580, it is determined whether there is more captured behavior to be evaluated. If so, processing loops back to block 550; otherwise, processing the list of significant sections is complete.

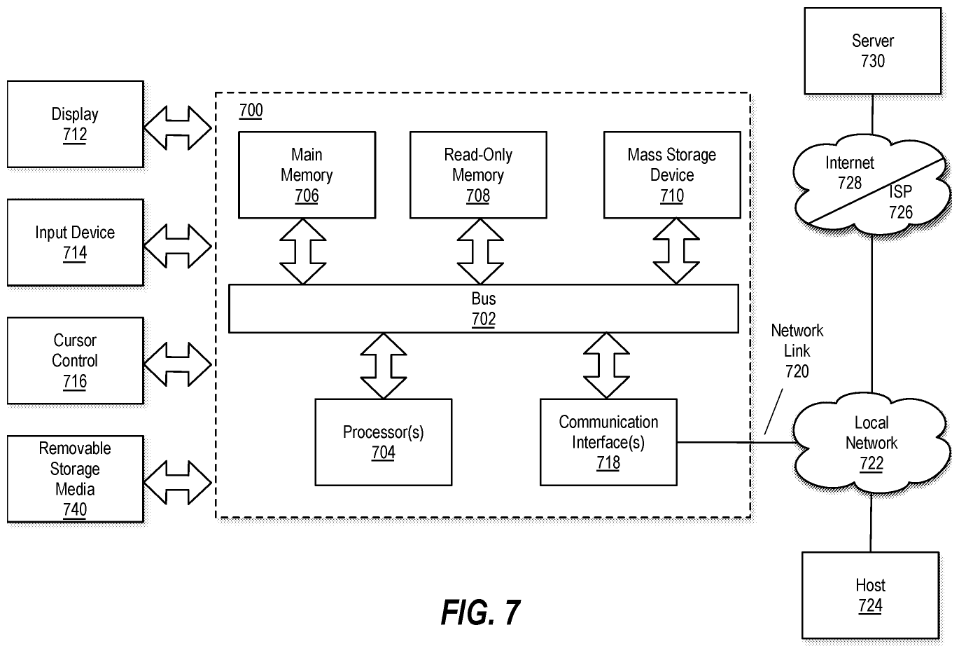

The processing described above with reference to the flow diagrams of FIGS. 4-5 may be implemented in the form of executable instructions stored on a machine readable medium and executed by a processing resource (e.g., a microcontroller, a microprocessor, a CPU core, a GPU core, an ASIC, an FPGA, or the like) and/or in the form of other types of electronic circuitry. For example, the processing may be performed by one or more virtual or physical computer systems of various forms, such as the computer system described below with reference to FIG. 7.

While in the context of the flow diagrams presented herein, a number of enumerated blocks are included, it is to be understood that the examples may include additional blocks before, after, and/or in between the enumerated blocks. Similarly, in some examples, one or more of the enumerated blocks may be omitted or performed in a different order.

### Example Computer System

FIG. 7 is an example of a computer system 700 with which some embodiments may be utilized. Notably, components of computer system 700 described herein are meant only to exemplify various possibilities. In no way should example computer system 700 limit the scope of the present disclosure. In the context of the present example, computer system 700 may represent a non-limiting example of a workload optimization system (e.g., workload optimization system 130) and includes a bus 702 or other communication mechanism for communicating information, and a processing resource (e.g., one or more hardware processors 704) coupled with bus 702 for processing information. The processing resource may be, for example, one or more general-purpose microprocessors or a system on a chip (SoC) integrated circuit.

Computer system 700 also includes a main memory 706, such as a random-access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, e.g., a magnetic disk, optical disk or flash disk (made of flash memory chips), is provided and coupled to bus 702 for storing information and instructions.

Computer system 700 may be coupled via bus 702 to a display 712, e.g., a cathode ray tube (CRT), Liquid Crystal Display (LCD), Organic Light-Emitting Diode Display (OLED), Digital Light Processing Display (DLP) or the like, for displaying information to a computer user. An input device 714, including alphanumeric and other keys, is coupled to bus 702 for communicating information and command selections to processor 704. Another type of user input device is cursor control 716, such as a mouse, a trackball, a trackpad, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Removable storage media 740 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 700 may implement the techniques described herein using customized hard-wired logic, one or more ASICs or FPGAs, firmware or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 710. Volatile media includes dynamic memory, such as main memory 706. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes interface circuitry 718 coupled to bus 702. The interface circuitry 718 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. As such, interface 718 may couple the processing resource in communication with one or more discrete accelerators 705 (e.g., one or more XPUs).

Interface 718 may also provide a two-way data communication coupling to a network link 720 that is connected to a local network 722. For example, interface 718 may be an integrated services digital network (ISDN) card, cable modem, satellite modem, or a modem to provide a data communication connection to a corresponding type of telephone line. As another example, interface 718 may be a local area network (LAN) card to provide a data communication connection to a compatible LAN. Wireless links may also be implemented. In any such implementation, interface 718 may send and receive electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718. The received code may be executed by processor 704 as it is received, or stored in storage device 710, or other non-volatile storage for later execution.

While many of the methods may be described herein in a basic form, it is to be noted that processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for facilitating hybrid communication according to embodiments and examples described herein.

Some embodiments pertain to Example 1 that includes a non-transitory machine-readable medium storing instructions, which when executed by a processor cause the processor to: during execution of a workload on a cluster computer system: identify a section of the workload as significant to a figure of merit (FOM) of the workload, wherein the workload comprises a high-performance computing (HPC) or artificial intelligence (AI) workload; for a portion of the section currently executing on a compute resource of a plurality of heterogeneous compute resources of a node of the cluster compute system, determine an alternate placement among the plurality of heterogeneous compute resources; and after predicting an improvement to the FOM based on the alternate placement, relocate the portion to the alternate placement.

Example 2 includes the subject matter of Example 1, wherein the plurality of heterogeneous compute resources include: (i) a central processing unit (CPU) or a CPU core, (ii) a graphics processing unit (GPU) or a GPU core, (iii) a field-programmable gate array (FPGA), and/or (iv) another type of accelerator.

Example 3 includes the subject matter of Example 2, wherein the compute resource is the CPU or the CPU core in a given socket or a given non-uniform memory access (NUMA) node and the alternate placement is a same CPU or CPU core in a different socket or a different NUMA node.

Example 4 includes the subject matter of Example 2, wherein the compute resource is the CPU or the CPU core and the alternate placement is the GPU, the GPU core, the FPGA, or said another type of accelerator.

Example 5 includes the subject matter of Example 2, wherein the compute resource is the GPU or the GPU core and the alternate placement is the CPU, the CPU core, the FPGA, or said another type of accelerator.

Example 6 includes the subject matter of Examples 1-5, wherein determination of an alternative placement includes predicting a best placement of the portion among the plurality of heterogeneous compute resources based on: a predicted increase or decrease in data transfer via interconnects coupling the plurality of heterogeneous compute resources; a predicted increase or decrease in memory access cost; a predicted increase or decrease in compute efficiency; parallel efficiency; a number of concurrent contexts allowed; a predicted increase or decrease of power utilization; a predicted increase or decrease in thermal behavior; a predicted increase or decrease in scheduling schemes; a predicted increase or decrease in concurrency; and/or other architectural features of the node.

Example 7 includes the subject matter of Examples 1-6, wherein identification of the section of the workload is based on an annotation, a string, an interrupt, or a profiling control contained within a binary representation of the workload that identifies a beginning or an end of the section.

Example 8 includes the subject matter of Examples 1-7, wherein the instructions further cause the processor to capture information indicative of a behavior of the workload, wherein identification of the section of the workload is based on the behavior.

Example 9 includes the subject matter of Example 8, wherein the behavior comprises execution of the section meeting or exceeding a measure of work done or a repetition threshold.

Example 10 includes the subject matter of Example 8, capturing of information indicative of the behavior of the workload is performed via function interposition, event queries, hardware counters, dynamic instruction count, and/or other measures of work.

Example 11 includes the subject matter of Example 10, wherein the information indicative of the behavior includes existence or non-existence of dependencies between the portion and one or more other portions of the section.

Example 12 includes the subject matter of Example 10, wherein the information indicative of the behavior includes whether the portion exhibits data locality.

Example 13 includes the subject matter of Examples 1-12, wherein the processor is internal to the cluster computer system.

Example 14 includes the subject matter of Examples 1-12, wherein the processor is external to the cluster computer system.

Some embodiments pertain to Example 15 that includes a method comprising: during execution of a workload on a cluster computer system: identifying a section of the workload as significant to a figure of merit (FOM) of the workload, wherein the workload comprises a high-performance computing (HPC) or artificial intelligence (AI) workload; for a portion of the section currently executing on a compute resource of a plurality of heterogeneous compute resources of a node of the cluster compute system, determining an alternate placement among the plurality of heterogeneous compute resources; and after predicting an improvement to the FOM based on the alternate placement, relocating the portion to the alternate placement.

Example 16 includes the subject matter of Example 15, wherein the plurality of heterogeneous compute resources include (i) a central processing unit (CPU) or a CPU core, (ii) a graphics processing unit (GPU) or a GPU core, (iii) a field-programmable gate array (FPGA), and/or (iv) another type of accelerator.

Example 17 includes the subject matter of Example 16, wherein the compute resource is the CPU or the CPU core in a given socket or a given non-uniform memory access (NUMA) node and the alternate placement is a same CPU or CPU core in a different socket or a different NUMA node.

Example 18 includes the subject matter of Example 16, wherein the compute resource is the CPU or the CPU core and the alternate placement is the GPU, the GPU core, the FPGA, or said another type of accelerator.

Example 19 includes the subject matter of Example 16, wherein the compute resource is the GPU or the GPU core and the alternate placement is the CPU, the CPU core, the FPGA, or said another type of accelerator.

Example 20 includes the subject matter of Examples 15-19, wherein said determining an alternative placement comprises predicting a best placement of the portion among the plurality of heterogeneous compute resources based on: a predicted increase or decrease in data transfer via interconnects coupling the plurality of heterogeneous compute resources; a predicted increase or decrease in memory access cost; a predicted increase or decrease in compute efficiency; parallel efficiency; a number of concurrent contexts allowed; a predicted increase or decrease of power utilization; a predicted increase or decrease in thermal behavior; a predicted increase or decrease in scheduling schemes; a predicted increase or decrease in concurrency; and/or other architectural features of the node.

Example 21 includes the subject matter of Examples 15-20, wherein said identifying a section of the workload is based on an annotation, a string, an interrupt, or a profiling control contained within a binary representation of the workload that identifies a beginning or an end of the section.

Example 22 includes the subject matter of Examples 15-21, further comprising capturing information indicative of a behavior of the workload, wherein said identifying a section of the workload is based on the behavior.

Example 23 includes the subject matter of Example 22, wherein the behavior comprises execution of the section meeting or exceeding a predetermined or configurable measure of work done or a repetition threshold.

Example 24 includes the subject matter of Example 22, wherein said capturing information indicative of a behavior of the workload is performed via function interposition, event queries, hardware counters, dynamic instruction count, and/or other measures of work.

Example 25 includes the subject matter of Example 24, wherein the information indicative of the behavior includes existence or non-existence of dependencies between the portion and one or more other portions of the section.

Example 26 includes the subject matter of Example 24, wherein the information indicative of the behavior includes whether the portion exhibits data locality.

Some embodiments pertain to Example 27 that includes a cluster computer system comprising: a compute node having a plurality of heterogeneous compute resources; a head node having a processor; and instructions that when executed by the processor or one or more of the plurality of heterogeneous compute resources cause the cluster computer system to: during execution of a workload on the cluster computer system: identify a section of the workload as significant to a figure of merit (FOM) of the workload, wherein the workload comprises a high-performance computing (HPC) or artificial intelligence (AI) workload; for a portion of the section currently executing on a compute resource of the plurality of heterogeneous compute resources, determine an alternate placement among the plurality of heterogeneous compute resources; and after predicting an improvement to the FOM based on the alternate placement, relocate the portion to the alternate placement.

Example 28 includes the subject matter of Example 27, wherein the plurality of heterogeneous compute resources include (i) a central processing unit (CPU) or a CPU core, (ii) a graphics processing unit (GPU) or a GPU core, (iii) a field-programmable gate array (FPGA), and/or (iv) another type of accelerator.

Example 29 includes the subject matter of Example 28, wherein the compute resource is the CPU or the CPU core in a given socket or a given non-uniform memory access (NUMA) node and the alternate placement is a same CPU or CPU core in a different socket or a different NUMA node.

Example 30 includes the subject matter of Example 28, wherein the compute resource is the CPU or the CPU core and the alternate placement is the GPU, the GPU core, the FPGA, or said another type of accelerator.

Example 31 includes the subject matter of Example 28, wherein the compute resource is the GPU or the GPU core and the alternate placement is the CPU, the CPU core, the FPGA, or said another type of accelerator.

Example 32 includes the subject matter of Examples 27-31, wherein determination of an alternative placement includes predicting a best placement of the portion among the plurality of heterogeneous compute resources based on: a predicted increase or decrease in data transfer via interconnects coupling the plurality of heterogeneous compute resources; a predicted increase or decrease in memory access cost; a predicted increase or decrease in compute efficiency; parallel efficiency; a number of concurrent contexts allowed; a predicted increase or decrease of power utilization; a predicted increase or decrease in thermal behavior; a predicted increase or decrease in scheduling schemes; a predicted increase or decrease in concurrency; and/or other architectural features of the node.

Example 33 includes the subject matter of Examples 27-32, wherein identification of the section of the workload is based on an annotation, a string, an interrupt, or a profiling control contained within a binary representation of the workload that identifies a beginning or an end of the section.

Example 34 includes the subject matter of Examples 27-33, wherein the instructions further cause the cluster computer system to capture information indicative of a behavior of the workload, wherein identification of the section of the workload is based on the behavior.

Example 35 includes the subject matter of Example 34, wherein the behavior comprises execution of the section meeting or exceeding a measure of work done or a repetition threshold.

Example 36 includes the subject matter of Example 34, wherein capturing of information indicative of the behavior of the workload is performed via function interposition, event queries, hardware counters, dynamic instruction count, and/or other measures of work.

Example 37 includes the subject matter of Example 34, wherein the information indicative of the behavior includes (i) existence or non-existence of dependencies between the portion and one or more other portions of the section and/or (ii) whether the portion exhibits data locality.

Some embodiments pertain to Example 38 that includes an apparatus that implements or performs a method of any of Examples 15-26.

Example 39 includes at least one machine-readable medium comprising a plurality of instructions, when executed on a computing device, implement or perform a method or realize an apparatus as described in any preceding Example.

Example 40 includes an apparatus comprising means for performing a method as claimed in any of Examples 15-26.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A non-transitory machine-readable medium storing instructions, which when executed by a processor cause the processor to:
during execution of a workload on a cluster computer system:
identify a section of the workload as significant to a figure of merit (FOM) of the workload, wherein the workload comprises a high-performance computing (HPC) or artificial intelligence (AI) workload;
for a portion of the section currently executing on a compute resource of a plurality of heterogeneous compute resources of a node of the cluster compute system, determine an alternate placement among the plurality of heterogeneous compute resources; and
after predicting an improvement to the FOM based on the alternate placement, relocate the portion to the alternate placement.

2. The non-transitory machine-readable medium of claim 1, wherein determination of an alternative placement includes predicting a best placement of the portion among the plurality of heterogeneous compute resources based on one or more of:
a predicted increase or decrease in data transfer via interconnects coupling the plurality of heterogeneous compute resources;
a predicted increase or decrease in memory access cost;
a predicted increase or decrease in compute efficiency;
parallel efficiency;
a number of concurrent contexts allowed;
a predicted increase or decrease of power utilization;
a predicted increase or decrease in thermal behavior;
a predicted increase or decrease in scheduling schemes;
a predicted increase or decrease in concurrency; and
other architectural features of the node.

3. The non-transitory machine-readable medium of claim 1, wherein identification of the section of the workload is based on an annotation, a string, an interrupt, or a profiling control contained within a binary representation of the workload that identifies a beginning or an end of the section.

4. The non-transitory machine-readable medium of claim 1, wherein the instructions further cause the processor to capture information indicative of a behavior of the workload, wherein identification of the section of the workload is based on the behavior.

5. The non-transitory machine-readable medium of claim 4, wherein the behavior comprises execution of the section meeting or exceeding a measure of work done or a repetition threshold.

6. The non-transitory machine-readable medium of claim 4, wherein capturing of information indicative of the behavior of the workload is performed via one or more of function interposition, event queries, hardware counters, dynamic instruction count, and other measures of work.

7. The non-transitory machine-readable medium of claim 6, wherein the information indicative of the behavior includes existence or non-existence of dependencies between the portion and one or more other portions of the section.

8. The non-transitory machine-readable medium of claim 6, wherein the information indicative of the behavior includes whether the portion exhibits data locality.

9. The non-transitory machine-readable medium of claim 1, wherein the processor is internal to the cluster computer system.

10. The non-transitory machine-readable medium of claim 1, wherein the processor is external to the cluster computer system.

11. A method comprising:
during execution of a workload on a cluster computer system:
identifying a section of the workload as significant to a figure of merit (FOM) of the workload, wherein the workload comprises a high-performance computing (HPC) or artificial intelligence (AI) workload;
for a portion of the section currently executing on a compute resource of a plurality of heterogeneous compute resources of a node of the cluster compute system, determining an alternate placement among the plurality of heterogeneous compute resources; and
after predicting an improvement to the FOM based on the alternate placement, relocating the portion to the alternate placement.

12. The method of claim 11, wherein said determining an alternative placement comprises predicting a best placement of the portion among the plurality of heterogeneous compute resources based on one or more of:
a predicted increase or decrease in data transfer via interconnects coupling the plurality of heterogeneous compute resources;
a predicted increase or decrease in memory access cost;
a predicted increase or decrease in compute efficiency;
parallel efficiency;
a number of concurrent contexts allowed;
a predicted increase or decrease of power utilization;
a predicted increase or decrease in thermal behavior;
a predicted increase or decrease in scheduling schemes;
a predicted increase or decrease in concurrency; and
other architectural features of the node.

13. The method of claim 11, wherein said identifying a section of the workload is based on an annotation, a string, an interrupt, or a profiling control contained within a binary representation of the workload that identifies a beginning or an end of the section.

14. The method of claim 11, further comprising capturing information indicative of a behavior of the workload, wherein said identifying a section of the workload is based on the behavior.

15. The method of claim 14, wherein the behavior comprises execution of the section meeting or exceeding a predetermined or configurable measure of work done or a repetition threshold.

16. The method of claim 14, wherein said capturing information indicative of a behavior of the workload is performed via one or more of function interposition, event queries, hardware counters, dynamic instruction count, and other measures of work.

17. The method of claim 16, wherein the information indicative of the behavior includes existence or non-existence of dependencies between the portion and one or more other portions of the section.

18. The method of claim 16, wherein the information indicative of the behavior includes whether the portion exhibits data locality.

19. A cluster computer system comprising:
a compute node having a plurality of heterogeneous compute resources;
a head node having a processor; and
instructions that when executed by the processor or one or more of the plurality of heterogeneous compute resources cause the cluster computer system to: during execution of a workload on the cluster computer system:
identify a section of the workload as significant to a figure of merit (FOM) of the workload, wherein the workload comprises a high-performance computing (HPC) or artificial intelligence (AI) workload;
for a portion of the section currently executing on a compute resource of the plurality of heterogeneous compute resources, determine an alternate placement among the plurality of heterogeneous compute resources; and
after predicting an improvement to the FOM based on the alternate placement, relocate the portion to the alternate placement.

20. The cluster computer system of claim 19, wherein the plurality of heterogeneous compute resources include one or more of (i) a central processing unit (CPU) or a CPU core, (ii) a graphics processing unit (GPU) or a GPU core, (iii) a field-programmable gate array (FPGA), and (iv) another type of accelerator.

21. The cluster computer system of claim 20, wherein the compute resource is the CPU or the CPU core in a given socket or a given non-uniform memory access (NUMA) node and the alternate placement is a same CPU or CPU core in a different socket or a different NUMA node.

22. The cluster computer system of claim 20, wherein the compute resource is the CPU or the CPU core and the alternate placement is the GPU, the GPU core, the FPGA, or said another type of accelerator.

23. The cluster computer system of claim 20, wherein the compute resource is the GPU or the GPU core and the alternate placement is the CPU, the CPU core, the FPGA, or said another type of accelerator.

24. The cluster computer system of claim 19, wherein determination of an alternative placement includes predicting a best placement of the portion among the plurality of heterogeneous compute resources based on one or more of:
a predicted increase or decrease in data transfer via interconnects coupling the plurality of heterogeneous compute resources;
a predicted increase or decrease in memory access cost;
a predicted increase or decrease in compute efficiency;
parallel efficiency;
a number of concurrent contexts allowed;
a predicted increase or decrease of power utilization;
a predicted increase or decrease in thermal behavior;
a predicted increase or decrease in scheduling schemes;
a predicted increase or decrease in concurrency; and
other architectural features of the node.

25. The cluster computer system of claim 19, wherein identification of the section of the workload is based on an annotation, a string, an interrupt, or a profiling control contained within a binary representation of the workload that identifies a beginning or an end of the section.

26. The cluster computer system of claim 19, wherein the instructions further cause the cluster computer system to capture information indicative of a behavior of the workload, wherein identification of the section of the workload is based on the behavior.

27. The cluster computer system of claim 26, wherein the behavior comprises execution of the section meeting or exceeding a measure of work done or a repetition threshold.

28. The cluster computer system of claim 26, wherein capturing of information indicative of the behavior of the workload is performed via one or more of function interposition, event queries, hardware counters, dynamic instruction count, and other measures of work.

29. The cluster computer system of claim 26, wherein the information indicative of the behavior includes one or more of (i) existence or non-existence of dependencies between the portion and one or more other portions of the section and (ii) whether the portion exhibits data locality.
